(19) United States
(12) Patent Application Publication
(10) Pub. No.: US 2020/0062091 A1
(43) Pub. Date: Feb. 27, 2020

(54) AWNING STRUCTURE

(71) Applicant: YING-CHE KAO, Chiayi County (TW)

(72) Inventor: YING-CHE KAO, Chiayi County (TW)

(21) Appl. No.: 16/113,126

(22) Filed: Aug. 27, 2018

(51) Int. Cl. B60J 7/00

(52) U.S. Cl. CPC B60J 7/0015

(57) ABSTRACT

This utility model is an awning structure, which is mainly applied between a vehicle body and a vehicle door member that is disposed on the vehicle body and capable of being pushed open to generate an access space. A main structure includes a reel device, a first fixing member, a shielding sheet body, and a second fixing member. The reel device has a telescopic shaft and a fixing apparatus connected to the telescopic shaft. The fixing apparatus is provided with a plurality of first fixing members attachable to the vehicle body. The shielding sheet body winds around the telescopic shaft, and the telescopic shaft controls the shielding sheet body to expand or contract. The second fixing member is disposed on the vehicle door member for fixing a clasp hole on the shielding sheet body.

### BACKGROUND OF THE INVENTION

### 1. Technical Field

This utility model is an awning, and in particular, an awning structure.

### 2. Background Art

Generally, most people choose driving as a means of transportation in rainy days. However, when getting on and off the vehicle, people must first open the vehicle door and then unfold or fold the umbrella. As a result, people still get wet, the rain splashes into the vehicle, and it makes inconvenient to get on and off the vehicle.

The detailed features and advantages of this utility model are described below in detail in embodiments, which are sufficient to enable any one skilled in the art to understand and implement the technical content of this utility model. In addition, according to the content disclosed in the specification, claims, and drawings, any one skilled in the art can readily understand the objective and advantages of this utility model.

### SUMMARY OF THE INVENTION

The main objective of this utility model is to respectively mount a first fixing member and a second fixing member on an awning on a vehicle body and a vehicle door member, so that when the vehicle door member is pushed open, a shielding sheet body is automatically pulled to shield an access space, thereby achieving the effect of shielding from sun and rain.

To achieve the foregoing objective, this utility model is an awning structure suitable to be applied between a vehicle body and a vehicle door member that is disposed on the vehicle body, and capable of being pushed open to generate an access space

The awning structures comprises a reel device, having a telescopic shaft and a fixing apparatus connected to the telescopic shaft, where the fixing apparatus is provided with a plurality of first fixing members attachable to the vehicle body; a shielding sheet body, defining a fixed side fixed to the telescopic axis and winding around the telescopic axis and a free side, where the telescopic shaft controls the shielding sheet body to expand or contract, and the free side is provided with at least one clasp hole; and at least one second fixing member, disposed on the vehicle door member, where the second fixing member is engaged with the clasp hole, so that after the vehicle door member is pushed open, the shielding sheet body is pulled to shield the access space.

According to an embodiment of the utility model, the first fixing member is a suction cup, a magnet or a hook.

According to an embodiment of the utility model, the second fixing member is a suction cup, a magnet or a hook.

According to an embodiment of the utility model, the vehicle door member includes a vehicle door and a window body mounted on the vehicle door.

According to an embodiment of the utility model, the second fixing member is disposed on the vehicle door.

According to an embodiment of the utility model, the second fixing member is disposed on the window body.

According to an embodiment of the utility model, the awning structure further includes at least one first buffer member disposed between the first fixing member and the fixing apparatus.

According to an embodiment of the utility model, the first buffer member is a spring.

According to an embodiment of this utility model, the awning structure further includes at least one second buffer member disposed between the second fixing member and the clasp hole.

According to an embodiment of the utility model, the second buffer member is a spring.

### BRIEF DESCRIPTION OF THE DRAWINGS

FIG. 1 is a schematic perspective view of a preferred embodiment of the utility model;

FIG. 2 is a schematic view of unfolding and folding of an awning of the utility model;

FIG. 3 is a schematic view of a mounting state when an awning of the utility model is applied to a vehicle;

FIG. 4 is a top view of a use state when an awning of the utility model is applied to a vehicle;

FIG. 5 is a top view of another use state when an awning of the utility model is applied to a vehicle;

FIG. 6 is a schematic view of unfolding and folding of another awning of the utility model; and

FIG. 7 is a schematic view of a use state when an awning of the utility model is applied inside a vehicle.

### DETAILED DESCRIPTION OF THE PREFERRED EMBODIMENTS

The embodiments of the utility model are described below by using specific examples, and those skilled in the art can readily understand other advantages and functions of the utility model from the disclosure of the specification.

The structures, proportions, sizes, and the like illustrated in the accompanying drawings of the specification are intended only to describe the content disclosed in the specification for understanding and reading by those skilled in the art, and not intended to limit the utility model, and therefore are not technically meaningful. Any structure modification, proportional relationship change, or size adjustment shall fall within the scope of the technical content disclosed in the utility model without affecting the effect and the objective of the utility model. In the meantime, the terms “a”, “two”, “upper”, and the like, as used in the specification, are only for convenience of description, and not intended to limit the implementation scope of the utility model, and changes or adjustments in their relative relationship are also considered to be within the implementation scope of the implementation without essentially changing the technical content.

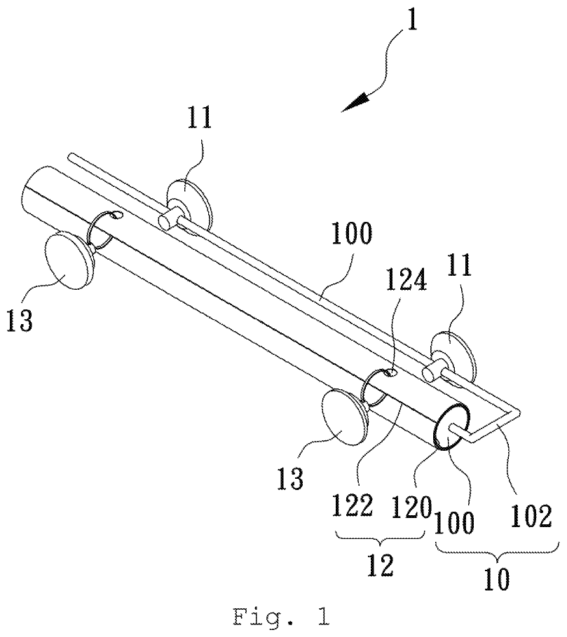

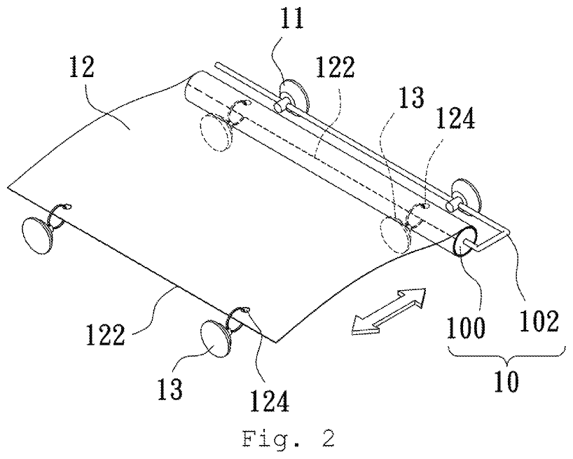

Referring to FIG. 1 and FIG. 2 for a perspective view of a preferred embodiment of the utility model and a schematic view of unfolding and folding of an awning, the utility model is an awning structure, which is applied between a vehicle body and a vehicle door member disposed on the vehicle body and capable of being pushed open to generate an access space.

The awning 1 mainly includes a reel device 10, a first fixing member 11 (which may be a suction cup, a magnet, or a hook), a shielding sheet body 12, and a second fixing member 13 (which may be a suction cup, a magnet, or a hook). The reel device 10 has a telescopic shaft 100 and a fixing apparatus 102 connected to the telescopic shaft 100. The fixing apparatus 102 is provided with a plurality of first fixing members 11 attachable to the vehicle body. The shielding sheet body 12 defines a fixed side 120 and a free side 122. The fixed side 120 is fixed on the telescopic shaft 100 so that the whole shielding sheet body 12 winds around the telescopic shaft 100, and the telescopic shaft 100 controls the shielding sheet body 12 to expand or contract. In addition, the free side 122 is provided with at least one clasp hole 124. The clasp hole 124 is mainly used to mount the second fixing member 13, to dispose the second fixing member 13 on the vehicle door member.

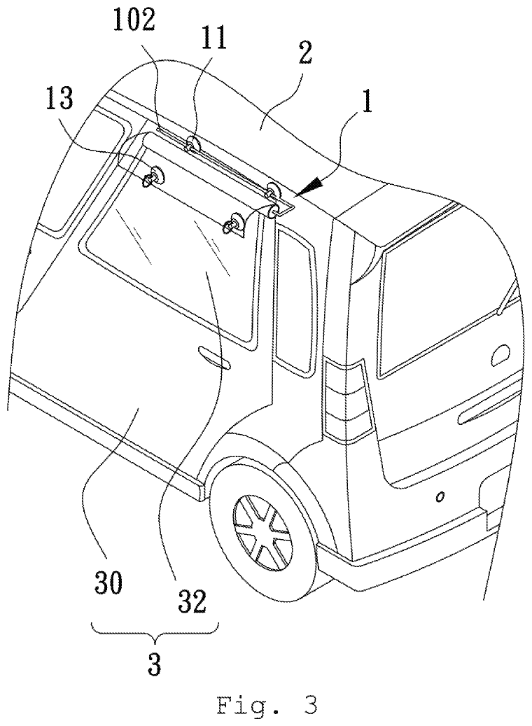

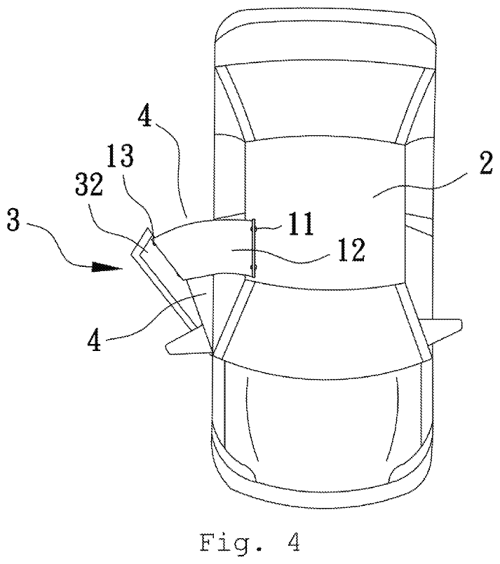

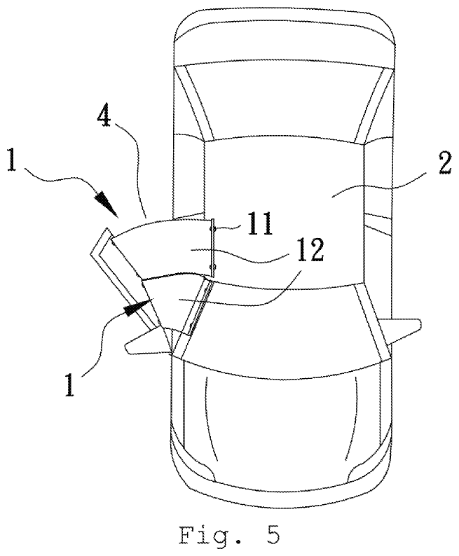

Also referring to FIG. 3, FIG. 4, and FIG. 5 for a schematic view of a use state when an awning of the utility model is applied to a vehicle, a top view of a use state when an awning is applied to a vehicle, and a top view of another use state, it can be seen in the drawings that in the utility model, the awning 1 is mainly mounted between the vehicle body 2 and the vehicle door member 3.

The vehicle door member 3 includes a vehicle door 30 and a window body 32 mounted on the vehicle door 30. During assembly, the second fixing member 13 may be first mounted on the vehicle door 30 or the window body 32. In this embodiment, for example, the second fixing member 13 is mounted on the window body 32. The first fixing member 11 disposed on the fixing apparatus 102 is disposed on the vehicle body 2. An access space 4 is generated between the vehicle door member 3 and the vehicle body 2 when the vehicle door member 3 is opened, and the second fixing member 13 on the window body 32 is also moved synchronously.

Therefore, the shielding sheet body 12 fixed on the second fixing member 13 is pulled. At this time, the shielding sheet body 12 covers the access space 4, thereby achieving the effect of shielding from sun and rain. In FIG. 5, two awnings 1 are used to cover the access space 4, thereby achieving the effect of complete shielding from sun and rain. In addition, after the awning 1 is unfolded, a telescopic support piece (not shown) is disposed on the shielding sheet body 12, to support the shielding sheet body 12 and prevent sinking due to excess expansion.

After the vehicle door member 3 is closed, the access space 4 disappears. At this time, the second fixing member 13 returns to an original position, and the shielding sheet body 12 together with the second fixing member 13 is retracted by the telescopic shaft 100. It can be known from the above that the awning 1 of the utility model is convenient to mount and can achieve the effect of shielding from sun and rain when used.

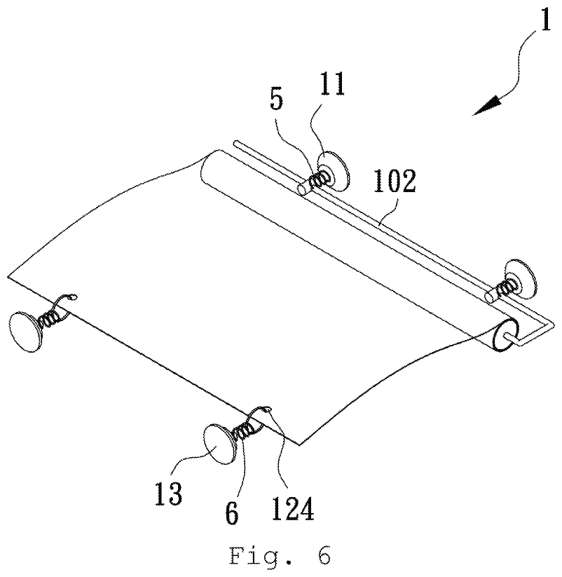

Further referring to FIG. 6 for a schematic view of unfolding and folding of another awning of the utility model, mainly, a first buffer member 5 (spring) is disposed between the first fixing member 11 and the fixing apparatus 102, and a second buffer member 6 (spring) is disposed between the second fixing member 13 and the clasp hole 124. The awning 1 of the utility model can be applied to any vehicle. Since most vehicles have their doors opened in an arc mode at different opening angles, the first buffer member 5 and the second cushioning member 6 can achieve the buffer effect when the whole is pulled, thereby improving the overall smoothness of pulling.

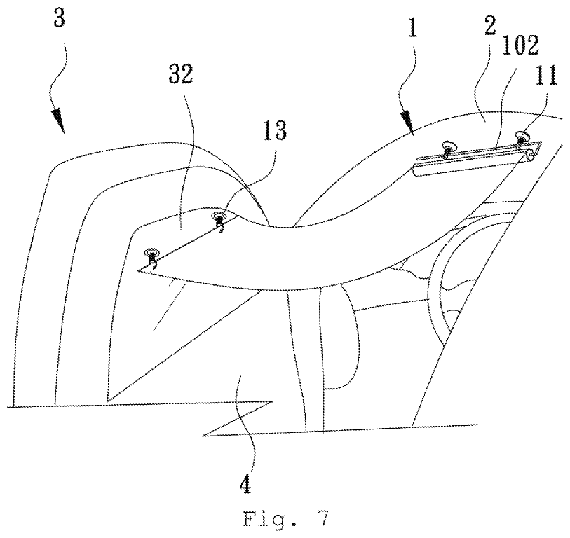

Further referring to FIG. 7 for a schematic view of a use state when an awning of the utility model is applied inside a vehicle, mainly, the awning 1 is mounted between the vehicle body 2 and the vehicle door member 3. For convenient use in rainy days, the second fixing member 13 is first mounted on an inner side of the window body 32, and the first fixing member 11 disposed on the fixing apparatus 102 is mounted on the roof of the vehicle body 2.

At this time, the first fixing member 11 can adopt a magnet or a hook. An access space 4 is generated between the vehicle door member 3 and the vehicle body 2 when the vehicle door member 3 is opened, and the second fixing member 13 on the window body 32 is also moved synchronously; therefore, the shielding sheet body 12 fixed on the second fixing member 13 is pulled. At this time, the shielding sheet body 12 covers the access space 4, thereby achieving the effect of shielding from rain in rainy days.

The foregoing embodiments merely illustrate the principles and effects of the utility model, and are not intended to limit the utility model. Any skilled in the art may modify the foregoing embodiments without departing from the spirit and scope of the utility model. Therefore, the protection scope of the utility model should be subject to the claims attached herewith.

What is claimed is:

1. An awning structure, which is applied between a vehicle body and a vehicle door member that is disposed on the vehicle body, and is capable of being pushed open to generate an access space, the awning structure comprises:
a reel device, having a telescopic shaft and a fixing apparatus connected to the telescopic shaft, wherein the fixing apparatus is provided with a plurality of first fixing members attachable to the vehicle body;
a shielding sheet body, defining a fixed side fixed to the telescopic axis and winding around the telescopic axis and a free side, wherein the telescopic shaft controls the shielding sheet body to expand or contract, and the free side is provided with at least one clasp hole; and
at least one second fixing member, disposed on the vehicle door member, wherein the second fixing member is engaged with the clasp hole, so that after the vehicle door member is pushed open, the shielding sheet body is pulled to shield the access space.

2. The awning structure according to claim 1, wherein the first fixing member is a suction cup, a magnet or a hook.

3. The awning structure according to claim 1, wherein the second fixing member is a suction cup, a magnet or a hook.

4. The awning structure according to claim 1, wherein the vehicle door member comprises a vehicle door and a window body mounted on the vehicle door.

5. The awning structure according to claim 4, wherein the second fixing member is disposed on the vehicle door.

6. The awning structure according to claim 4, wherein the second fixing member is disposed on the window body.

7. The awning structure according to claim 1, further comprising at least one first buffer member disposed between the first fixing member and the fixing apparatus.

8. The awning structure according to claim 7, wherein the first buffer member is a spring.

9. The awning structure according to claim 1, further comprising at least one second buffer member disposed between the second fixing member and the clasp hole.

10. The awning structure according to claim 9, wherein the second buffer member is a spring.
